(19) United States
(12) Patent Application Publication
(10) Pub. No.: US 2026/0296943 A1
(43) Pub. Date: Oct. 1, 2026

(54) A WATER TREATMENT CARTRIDGE

(71) Applicant: HCL Technologies Limited, New Delhi (IN)

(72) Inventors: Akash Mohan Salunkhe, Satara (IN); Yuvaraj D Patil, Kolhapur (IN)

(21) Appl. No.: 19/443,090

(22) Filed: Jan. 8, 2026

(30) Foreign Application Priority Data
Mar. 31, 2025 (IN) 202511031864

(51) Int. Cl. C02F 9/20; C02F 1/00; C02F 1/28; C02F 1/68; C02F 5/00; C02F 101/12; C02F 103/02

(52) U.S. Cl. CPC C02F 9/20; C02F 1/003; C02F 1/008; C02F 1/283; C02F 1/686; C02F 5/00; C02F 2101/12; C02F 2103/026; C02F 2201/006; C02F 2209/10; C02F 2209/40; C02F 2209/42; C02F 2209/445; C02F 2303/02; C02F 2303/24; C02F 2307/06; C02F 2307/12

(57) ABSTRACT

A water treatment cartridge is disclosed. The water treatment cartridge may include a solution dispensing system. The solution dispensing system may include a reservoir configured to store an antimicrobial solution. The solution dispensing system may further include a level sensor positioned with the reservoir. The solution dispensing system may further include an electronic pumping mechanism coupled to the reservoir. The water treatment cartridge may further include a control unit communicatively coupled to each of the level sensor and the electronic pumping mechanism.

### DESCRIPTION

### Technical Field

This disclosure relates generally to filtration devices, and more particularly to a water treatment cartridge.

### Background

Hard water is a common problem that may adversely affect household appliances and personal care (i.e., skin care and hair care). Hard water is composed of minerals like calcium and magnesium. Hard water may form a deposit (known as scale) in plumbing systems, appliances, and fixtures resulting in reduced efficiency and lifespan of such plumbing systems, appliances, and fixtures. The scale buildup may necessitate frequent maintenance, increase energy consumption, and may lead to premature failure of appliances.

In addition to damaging the appliances, hard water may negatively impact personal care. Hard water may leave residue on skin and hair causing dryness, irritation, and exacerbating conditions such as dandruff, eczema, and psoriasis. Furthermore, hard water minerals may dull hair and make the hair brittle, leading to breakage and thinning. Existing solutions, such as water softeners may reduce mineral content but lack water quality enhancements, and are not optimally monitored.

Therefore, there is a need for a comprehensive water treatment cartridge that may solve the limitations stated above or any other limitations associated with the known arts.

### SUMMARY

In one embodiment, a water treatment cartridge is disclosed. In one example, the water treatment cartridge may include a solution dispensing system. The solution dispensing system may include a reservoir configured to store an antimicrobial solution. The reservoir may include a reservoir outlet. The solution dispensing system may further include a level sensor positioned within the reservoir. The level sensor is configured to detect a level of the antimicrobial solution in the reservoir. The solution dispensing system may further include an electronic pumping mechanism coupled to the reservoir. The electronic pumping mechanism may include a dispensing nozzle. The electronic pumping mechanism may further include an electronic pump in fluid communication with the reservoir outlet and the dispensing nozzle. The electronic pump is configured to draw the antimicrobial solution from the reservoir outlet. The electronic pump is further configured to dispense the antimicrobial solution through the dispensing nozzle. The water treatment cartridge may further include a control unit communicatively coupled to each of the level sensor and the electronic pumping mechanism. The control unit is configured to receive configuration information corresponding to the solution dispensing system from a user device. The configuration information may include at least one of a user-defined dispensing time interval or a user-defined dosage of the antimicrobial solution. The control unit is further configured to determine in real-time, the level of the antimicrobial solution in the reservoir through the level sensor. The control unit is further configured to generate in real-time, a dispensing signal for the electronic pumping mechanism based on the configuration information, the determined level, and a predefined threshold level. The dispensing signal is one of an activation signal or an inactivation signal.

In another embodiment, a plumbing device is disclosed. In one example, the plumbing device may include a water treatment cartridge. The water treatment cartridge may include a solution dispensing system. The solution dispensing system may include a reservoir configured to store an antimicrobial solution. The reservoir may include a reservoir outlet. The solution dispensing system may further include a level sensor positioned within the reservoir. The level sensor is configured to detect a level of the antimicrobial solution in the reservoir. The solution dispensing system may further include an electronic pumping mechanism coupled to the reservoir. The electronic pumping mechanism may include a dispensing nozzle. The electronic pumping mechanism may further include an electronic pump in fluid communication with the reservoir outlet and the dispensing nozzle. The electronic pump is configured to draw the antimicrobial solution from the reservoir outlet. The electronic pump is further configured to dispense the antimicrobial solution through the dispensing nozzle. The water treatment cartridge may further include a control unit communicatively coupled to each of the level sensor and the electronic pumping mechanism. The control unit is configured to receive configuration information corresponding to the solution dispensing system from a user device. The configuration information may include at least one of a user-defined dispensing time interval or a user-defined dosage of the antimicrobial solution. The control unit is further configured to determine in real-time, the level of the antimicrobial solution in the reservoir through the level sensor. The control unit is further configured to generate in real-time, a dispensing signal for the electronic pumping mechanism based on the configuration information, the determined level, and a predefined threshold level. The dispensing signal is one of an activation signal or an inactivation signal.

In yet another embodiment, a method for operating a water treatment cartridge is disclosed. In one example, the method may include receiving configuration information corresponding to a solution dispensing system from a user device. The configuration information may include at least one of a user-defined dispensing time interval or a user-defined dosage of the antimicrobial solution. The solution dispensing system may include a reservoir configured to store an antimicrobial solution. The reservoir may include a reservoir outlet. The solution dispensing system may further include a level sensor positioned within the reservoir. The level sensor is configured to detect a level of the antimicrobial solution in the reservoir. The solution dispensing system may include an electronic pumping mechanism coupled to the reservoir. The electronic pumping mechanism may include a dispensing nozzle. The electronic pumping mechanism may further include an electronic pump in fluid communication with the reservoir outlet and the dispensing nozzle. The electronic pump is configured to draw the antimicrobial solution from the reservoir outlet. The electronic pump is further configured to dispense the antimicrobial solution through the dispensing nozzle. The method may further include determining in real-time the level of the antimicrobial solution in the reservoir through the level sensor. The method may further include generating in real-time a dispensing signal for the electronic pumping mechanism based on the configuration information, the determined level, and a predefined threshold level. The dispensing signal is one of an activation signal or an inactivation signal.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a cross-sectional view of a water treatment cartridge, in accordance with an embodiment.

FIG. 2A illustrates a cross-sectional view of the water treatment cartridge retrofitted with a tap, in accordance with an embodiment.

FIG. 2B illustrates a cross-sectional view of the water treatment cartridge retrofitted with a shower head, in accordance with an embodiment.

FIG. 2C illustrates a cross-sectional view of the water treatment cartridge retrofitted with a geyser, in accordance with an embodiment.

FIG. 3 illustrates a block diagram of an exemplary Internet of Things (IoT) system for operating the water treatment cartridge, in accordance with some embodiments.

FIG. 4 illustrates a flow diagram of an exemplary process for operating the water treatment cartridge, in accordance with some embodiments.

FIG. 5 illustrates a flow diagram of an exemplary process for determining a filtration performance of the water treatment cartridge, in accordance with some embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

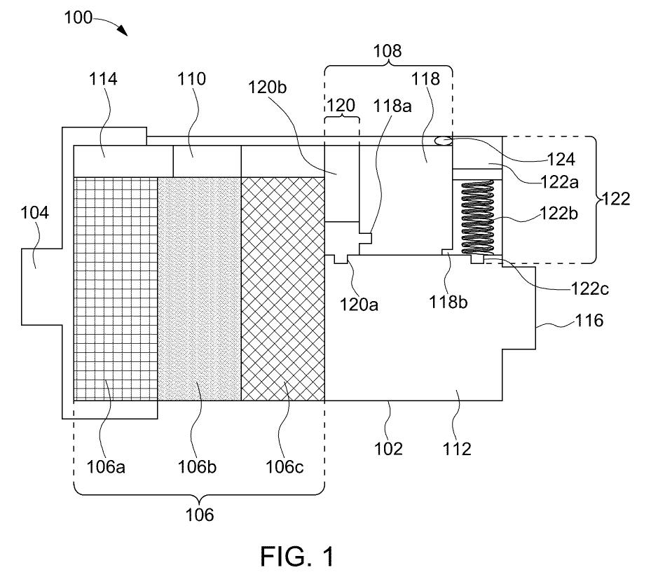

Referring now to FIG. 1, a cross-sectional view of a water treatment cartridge 100 is illustrated, in accordance with some embodiments. The water treatment cartridge 100 may include a housing 102. The housing 102 may enclose an inlet 104, a filtration system 106, a solution dispensing system 108, a control unit 110, a mixing chamber 112, a power source 114, a charging port 124, and an outlet 116. In an embodiment, the housing 102 may be made of durable, non-corrosive material resistant to high temperatures and pressure (for example, stainless steel, titanium, nickel alloys, etc.). The housing 102 may feature threaded connections compatible with standard plumbing systems for ease of installations. This makes the housing 102 retrofittable with a piping arrangement via the inlet 104 and the outlet 116.

The water treatment cartridge 100 may further include a set of sensors (not shown) at the inlet 104 and the outlet 116. In an embodiment, the set of sensors may include a flow sensor and/or a Total Dissolved Solids (TDS) sensor. In an alternate embodiment, the set of sensors may include a flow sensor or a TDS sensor. The flow sensors may measure flow rate of water into the housing 102 of the water cartridge 100. The TDS sensors may measure dissolved combined content of all inorganic and organic substances present in water in molecular, ionized, or micro-granular suspended form.

The water treatment cartridge 100 may further include a filtration system 106. The filtration system 106 may include a set of filters. The set of filters may include a prefilter module 106a, an activated carbon filter module 106b, and an anti-scaling filter module 106c. The prefilter module 106a may be positioned facing the inlet 104. As water enters the filtration system 106, the pre-filter module 106a may remove large particles (for example, silt, sand, gravel, algae, decaying plants, etc.) from water to obtain pre-filtered water. Further, the pre-filtered water may pass through the activated carbon filter 106b. The activated carbon filter 106b may be serially positioned next to the prefilter module 106a. The activated carbon filter 106b may remove inorganic compounds (for example, chlorine, taste/odor- causing substances, etc.) from the pre-filtered water to obtain carbon filtered water. Further, the carbon-filtered water may pass through the anti-scaling filter module 106c. The anti-scaling filter module 106c may be serially positioned next to the activated carbon filter module 106b. The anti-scaling filter module 106c may reduce hardness and improve the quality of the carbon-filtered water by removing calcium and magnesium ions, preventing scale buildup on appliance surfaces and heating elements to obtain filtered water.

Further, the solution dispensing system 108 may include a reservoir 118, a level sensor (not shown), and an electronic pumping mechanism 120. The control unit 110 is communicatively coupled to each of the level sensor and the electronic pumping mechanism 120. The reservoir 118 is a sealed compartment configured to store an antimicrobial solution. In a preferred embodiment, the antimicrobial solution is a neem solution. In other embodiments, the antimicrobial solution may be any other natural and/organic solution with known health benefits. Alternatively, the antimicrobial solution may include dermatological medication prescribed to a user.

The reservoir 118 may include a first reservoir outlet 118a and a second reservoir outlet 118b. The level sensor is positioned within the reservoir 118. The level sensor is configured to detect a level of the antimicrobial solution in the reservoir 118. The electronic pumping mechanism 120 is coupled to the reservoir 118. The electronic pumping mechanism 120 may include a first dispensing nozzle 120a and an electronic pump 120b. The electronic pump 120b in fluid communication with the first reservoir outlet 118a and the first dispensing nozzle 120a. The electronic pump 120b is configured to draw the antimicrobial solution from the first reservoir outlet 118a. The electronic pump 120b is further configured to dispense the antimicrobial solution through the dispensing nozzle 120a.

The control unit 110 communicatively coupled to each of the level sensors and the electronic pumping mechanism 120. The control unit 110 is configured to receive configuration information corresponding to the solution dispensing system 108 from a user device (for example, through a mobile phone). The configuration information may include at least one of a user-defined dispensing time interval or a user-defined dosage of the antimicrobial solution. In other words, a user may decide a time interval to dispense the antimicrobial solution and the dosage of the antimicrobial solution to be dispensed in the filtered water through a mobile application. The control unit 110 is further configured to determine in real-time, the level of the antimicrobial solution in the reservoir 118 through the level sensor. The control unit 110 is further configured to generate in real-time, a dispensing signal for the electronic pumping mechanism 120 based on the configuration information, the determined level, and a predefined threshold level. The dispensing signal may be one of an activation signal or an inactivation signal. The activation signal may enable the electronic pumping mechanism 120 to dispense the user-defined dosage of the antimicrobial solution at the user-defined dispensing time interval.

As the activation signal is generated, the electronic pump 120b may dispense the antimicrobial solution through the first dispensing nozzle 120a. As the inactivation signal is generated, the control unit 110 may disable the electronic pumping mechanism 120 to dispense the antimicrobial solution. In an embodiment, the power source 114 may provide power to the control unit 110, the electronic pumping mechanism 120, the flow sensors, the TDS sensors, and the level sensor. In an embodiment, the power source 114 may be charged through the charging port 124 (for example, a USB port, a USB-C port, etc.).

In an embodiment, the control unit 110 is further configured to determine a filtration performance through the set of sensors. The filtration performance is indicative of at least one of a life of the set of filter modules or a filtration quality of the set of filter modules. The control unit 110 is further configured to render the level of the antimicrobial solution and the filtration performance. The control unit 110 is further configured to perform a first comparison of the level of the antimicrobial solution with a predefined threshold level. The control unit 110 is further configured to perform a second comparison of the filtration performance with a predefined threshold performance. The control unit 110 is further configured to render a notification corresponding to unsuccessful comparison when at least one of the first comparison or the second comparison is unsuccessful.

Additionally, the solution dispensing system 108 may include a mechanical pumping mechanism 122 coupled to the reservoir 118. The mechanical pumping mechanism 122 is configured to dispense the antimicrobial solution manually from the reservoir 118. The mechanical pumping mechanism 122 may include a push button 122a, a return spring 122b,and a second dispensing nozzle 122c. The return spring 122b may be coupled to the push button 122a and the second reservoir outlet 118b. The return spring 122b is configured to generate a suction pressure on the reservoir 118 when the push button 122a is pressed to draw the antimicrobial solution from the second reservoir outlet 118b. The return spring 122b is further configured to dispense the antimicrobial solution through the second dispensing nozzle 122c. Further, the mixing chamber 112 may ensure uniform integration of the antimicrobial solution into the filtered water. Finally, an anti-microbial solution infused, softened water may exit the housing 102 through the outlet 116.

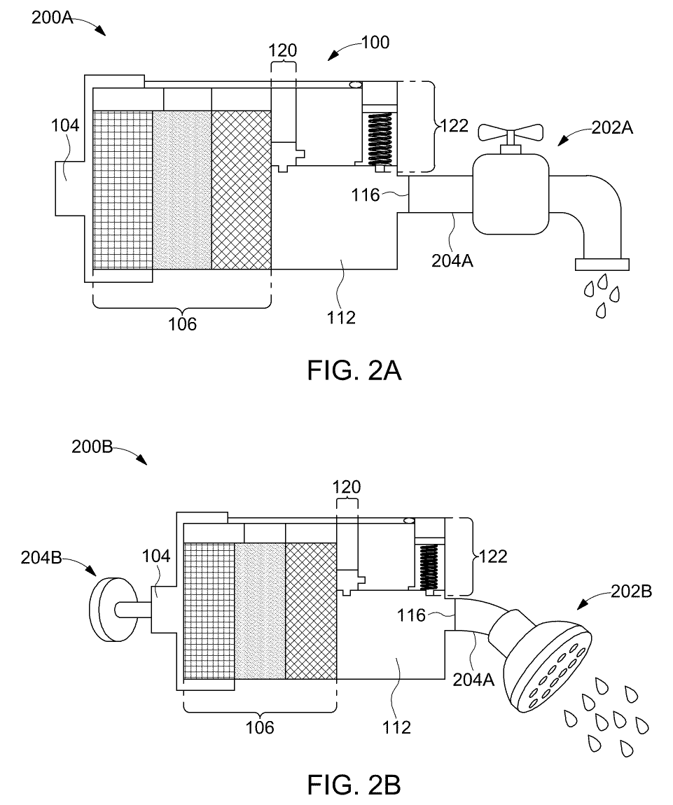

Referring now to FIG. 2A, a cross-sectional view 200A of the water treatment cartridge 100 retrofitted with a tap 202A is illustrated, in accordance with an embodiment. FIG. 2 is explained in conjunction with FIG. 1. The water treatment cartridge 100 may be retrofitted into a piping arrangement 204A through the inlet 104 and the outlet 116. The water treatment cartridge 100 is designed to connect between the piping arrangement 204A and the tap 202A. Water may flow through the piping arrangement 204A and enter into the water treatment cartridge 100 through the inlet 104. Once the water enters the water treatment cartridge 100, the water may get filtered by the filtration system 106 and additionally an antimicrobial solution may be dispensed into the filtered water through the electronic pumping mechanism 120 and/or the mechanical pumping mechanism 122 (as already explained in detail in conjunction with FIG. 1). Once the anti-microbial solution is dispensed into the filtered water in the mixing chamber 112, the water may exit the water treatment cartridge 100 through the outlet 116 and flow through the tap 202A. The water treatment cartridge 100 may prevent scale buildup in the tap 202A and the piping arrangement 204A. The water treatment cartridge 100 may supply softened, antimicrobial solution infused and filtered water.

Referring now to FIG. 2B, a cross-sectional view 200B of the water treatment cartridge 100 retrofitted with a shower head 202B is illustrated, in accordance with an embodiment. FIG. 2B is explained in conjunction with FIGS. 1 and 2A. The water treatment cartridge 100 may be retrofitted into a piping arrangement 204B through the inlet 104 and the outlet 116. The water treatment cartridge 100 is designed to connect between the piping arrangement 204B and the shower head 202B. Water may flow through the piping arrangement 204B and enter into the water treatment cartridge 100 through the inlet 104. Once the water enters the water treatment cartridge 100, the water may get filtered by the filtration system 106 and additionally an antimicrobial solution may be dispensed into the filtered water through the electronic pumping mechanism 120 and/or the mechanical pumping mechanism 122 (as already explained in detail in conjunction with FIG. 1). Once the anti-microbial solution is dispensed into the filtered water in the mixing chamber 112, the water may exit the water treatment cartridge 100 through the outlet 116 and flow through the shower head 202B. The water treatment cartridge 100 may prevent scale buildup in the shower head 202B and the piping arrangement 204B. The water treatment cartridge 100 may supply softened, antimicrobial solution infused and filtered water.

Referring now to FIG. 2C, a cross-sectional view 200C of the water treatment cartridge 100 retrofitted with a geyser 202C is illustrated, in accordance with an embodiment. FIG. 2C is explained in conjunction with FIGS. 1, 2A, and 2B. The geyser may include a cold water piping arrangement 204C and a hot water piping arrangement 206C. The water treatment cartridge 100 may be retrofitted into the cold-water piping arrangement 204C through the inlet 104 and the outlet 116. The water treatment cartridge 100 is designed to connect between the cold-water piping arrangement 204C and the geyser 202C. Water may flow through the cold-water piping arrangement 204C and enter into the water treatment cartridge 100 through the inlet 100. Once the water enters the water treatment cartridge 100, the water may get filtered by the filtration system 106 and additionally an anti-microbial solution may be dispensed into the filtered water through the electronic pumping mechanism 120 and/or the mechanical pumping mechanism 122 (as already explained in greater detail in conjunction with FIG. 1). Once the anti-microbial solution is dispensed into the filtered water in the mixing chamber 112, the water may exit the water treatment cartridge 100 through the outlet 116 and flow to the geyser 202C. The water treatment cartridge 100 may prevent scale buildup in the geyser 202C, the cold-water piping arrangement 204A, the hot water piping arrangement 204B. The water treatment cartridge 100 may supply softened, antimicrobial solution infused and filtered water.

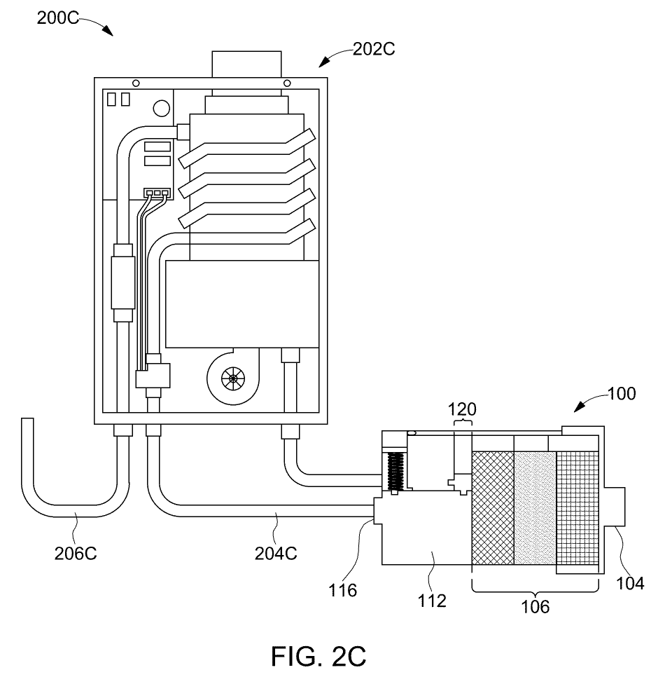

Referring now to FIG. 3, a block diagram of an exemplary Internet of Things (IoT) system 300 for operating the water treatment cartridge 100 is illustrated, in accordance with some embodiments. FIG. 3 is explained in conjunction with FIGS. 1 – 2A-C. The IoT system 300 may include the control unit 110. The control unit 110 may be enclosed within the housing 102, as described in detail in conjunction with FIG. 1. The control unit 110 may include a processor 302. The control unit 110 may also include a memory 304 communicatively coupled to the processor 302. The memory 304 may store processor-executable instructions that, when executed by the processor 302, may cause the processor 302 to operate the water treatment cartridge 100, in accordance with aspects of the present disclosure. The memory 304 may also store various data (for example, sensor data, the user-defined dosage, the user-defined dispensing time interval, threshold values (such as the predefined threshold level and the predefined threshold performance, and the like) that may be captured, processed, and/or required by the IoT system 300.

The memory 304 may include a level determining module 306, a signal generating module 308, and a performance determining module 310. The system 300 may include a user device 312. By way of an example, the user device 312 may be, but may not be limited to, desktop, laptop, notebook, netbook, tablet, smartphone, mobile phone, or any other computing device, in accordance with some embodiments of the present disclosure. The user device 312 may be communicatively connected to the control unit 110 through a communication network for sending or receiving various data. The communication network may include, for example, but may not be limited to, a wireless fidelity (Wi-Fi) network, a light fidelity (Li-Fi) network, a local area network (LAN), a wide area network (WAN), an infrared (IR) network, a radio frequency (RF) network, and a combination thereof. In some embodiments, the user device 312 may interact with the control unit 110 through a Graphical User Interface (GUI) of an application.

In some embodiments, at least one of a flow sensor 314 or a TDS sensor 316 may be positioned at the inlet 104 and the outlet 116 of the water treatment cartridge 100. Each of the flow sensor 314 and/or the TDS sensor 316 may be communicatively coupled to the control unit 110. The flow sensor 314 may detect flow values of water at the inlet 104 (i.e., before filtering and before antimicrobial liquid dispensing) and the outlet 116 (i.e., after filtering and after antimicrobial liquid dispensing). The flow sensor 314 may send the detected values to the control unit 110. Further, the performance determining module 310 may calculate a difference between the flow values of water at the inlet 104 and the outlet 116. Based on the difference, the control unit 110 may determine a life of the set of filter modules. The difference between the flow values of water at the inlet 104 and the outlet 116 may be indicative of the life of the set of filter modules. For example, when the difference increases, at least one of the set of filter modules may be compromised with blockage. This may indicate degradation of filter life. When the difference increases to a value higher than a predefined threshold, there may be a requirement of replacing the set of filter modules.

The TDS sensor 316 may detect TDS value of water at the inlet 104 (i.e., before filtering and before antimicrobial liquid dispensing) and the outlet 116 (i.e., after filtering and after antimicrobial liquid dispensing) The TDS sensor 316 may send the detected values to the control unit 110. Further, the performance determining module 310 may calculate a difference between the TDS values of water at the inlet 104 and the outlet 116. Based on the difference, the control unit 110 may determine a filtration quality of the set of filter modules. The difference between the TDS values of water at the inlet 104 and the outlet 116 may be indicative of filtration quality of the set of filter modules. For example, when the difference decreases, at least one of the set of filter modules may be functioning inefficiently. This may indicate poor filtration performance. When the difference decreases to a value lower than a predefined threshold, there may be a requirement of replacing the set of filter modules. It should be apparent to a person skilled in the art that, in some embodiments, any other additional or alternative sensors may be used in place of or along with the flow sensor 314 and/or the TDS sensor 316 to determine one or more aspects of the filtration performance (i.e., the life of the set of filter modules and/or the filtration quality of the set of filter modules).

Further, the performance determining module 310 may render, through the user device 312, the filtration performance on the GUI. Additionally, the performance determining module 310 may perform a comparison of the filtration performance with a predefined threshold performance. The performance determining module 310 may then render, through the user device 312, a notification corresponding to unsuccessful comparison when the comparison of the filtration performance with the predefined threshold performance is unsuccessful. By way of an example, the notification may be “Filtration performance is not optimal. Kindly replace one or more of the filters.”

Further, the IoT system 300 may include a level sensor 318 positioned within the reservoir 118 of the solution dispensing system 108. The level sensor 318 may be communicatively coupled to the control unit 110. The level sensor 318 may be configured to detect a level of the antimicrobial solution in the reservoir 118. The level sensor 318 may send the detected values to the control unit 110. Further, the level determining module 306 may determine in real-time, the level of the antimicrobial solution in the reservoir 118. The level determining module 306 may then render, through the user device 312, the level of the antimicrobial solution on the GUI.

Additionally, the performance determining module 310 may perform a comparison of the level of the antimicrobial solution with a predefined threshold level. Further, the performance determining module 310 may render, through the user device 312, a notification corresponding to unsuccessful comparison when the comparison between the determined level and the predefined threshold level is unsuccessful. By way of an example, the notification may be “Antimicrobial liquid volume is too low. Kindly refill the reservoir.”

The user may also send configuration information for the water treatment cartridge 100 to the control unit 110 via the GUI on the user device 312. The configuration information may include at least one of a user-defined dispensing time interval or a user-defined dosage of the antimicrobial solution (i.e., a quantity of disposing the antimicrobial solution required to be dispensed). The user-defined dispensing time interval may be selected from a set of frequency options, such as ‘low frequency (~ every 120 seconds)’, ‘medium frequency (~ every 60 seconds)’, and ‘high frequency (~ every 30 seconds)’. The user-defined dosage may be selected from a set of dosage options provided on the GUI, such as ‘low dosage’, ‘medium dosage’, and ‘high dosage’. In an embodiment, a combination of the user-defined dispensing time interval and the user-defined dosage may be provided by the user in the configuration information.

The signal generating module 308 may receive the configuration information corresponding to the solution dispensing system from the user device 312. Further, the signal generating module 308 may generate in real-time a dispensing signal for the electronic pumping mechanism based on the configuration information, the determined level, and a predefined threshold level. The dispensing signal may be one of an activation signal or an inactivation signal. The activation signal may enable the electronic pumping mechanism to dispense the user-defined dosage of the antimicrobial solution at the user-defined dispensing time interval. The inactivation signal may disable the electronic pumping mechanism to dispense the antimicrobial solution. This has already been described in detail in conjunction with FIG. 1.

It should be noted that all such aforementioned modules 306 – 310 may be represented as a single module or a combination of different modules. Further, as will be appreciated by those skilled in the art, each of the modules 306 – 310 may reside, in whole or in parts, on one device or multiple devices in communication with each other. In some embodiments, each of the modules 306 – 310 may be implemented as dedicated hardware circuit comprising custom application-specific integrated circuit (ASIC) or gate arrays, off-the-shelf semiconductors such as logic chips, transistors, or other discrete components. Each of the modules 306 – 310 may also be implemented in a programmable hardware device such as a field programmable gate array (FPGA), programmable array logic, programmable logic device, and so forth. Alternatively, each of the modules 306 – 310 may be implemented in software for execution by various types of processors (e.g., processor 302). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module, and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for operating the water treatment cartridge 100. For example, the exemplary IoT system 300 and the associated control unit 110, may validate images with observations by the processes discussed herein. In particular, as will be appreciated by those of ordinary skill in the art, control logic and/or automated routines for performing the techniques and steps described herein may be implemented by the IoT system 300 and the associated control unit 110, either by hardware, software, or combinations of hardware and software. For example, suitable code may be accessed and executed by the one or more processors on the IoT system 300 to perform some or all of the techniques described herein. Similarly, application specific integrated circuits (ASICs) configured to perform some, or all of the processes described herein may be included in the one or more processors on the IoT system 300.

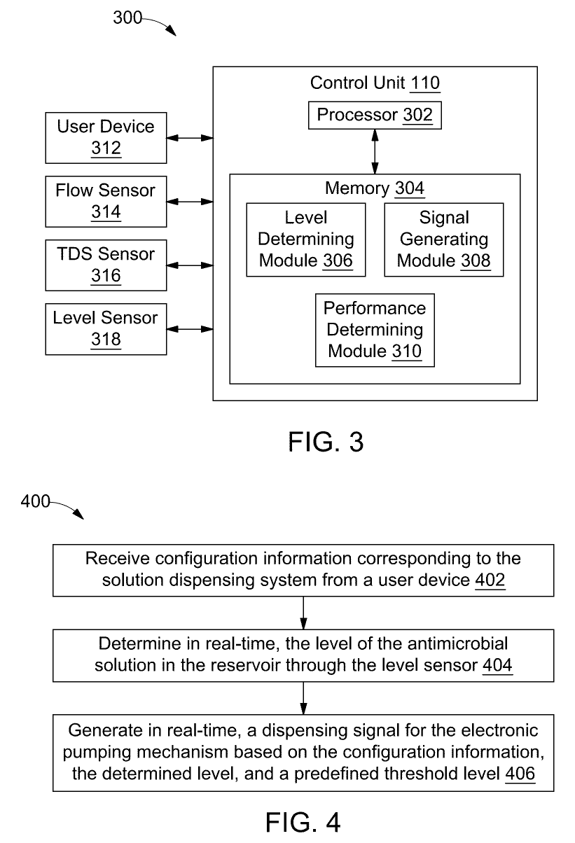

Referring now to FIG. 4, a flow diagram of an exemplary process 400 for operating the water treatment cartridge 100 is illustrated, in accordance with some embodiments. FIG. 4 is explained in conjunction with FIGS. 1-3. The process 400 may be implemented by a control unit (for example, the control unit 110) within a housing (for example, the housing 102). The housing may include an inlet (for example, the inlet 104), a filtration system (for example, the filtration system 106), the solution dispensing system (for example, the solution dispensing system 108), and an outlet (for example, the outlet 116). The housing may be retrofittable with a piping arrangement via the inlet and the outlet. The housing may further include a set of sensors at the inlet and the outlet. The set of sensors may include a flow sensor (for example, the flow sensor 314) and a TDS sensor (for example, the TDS sensor 316). The filtration system may include a set of filters serially arranged within the housing in proximity to the inlet. The set of filters may include a prefilter module (for example, the prefilter module 106a) positioned facing the inlet. The set of filters may further include an activated carbon filter module (for example, the activated carbon filter module 106b) serially positioned next to the prefilter module. The set of filters may further include an anti-scaling filter module (for example, the anti-scaling filter module 106c) serially positioned next to the activated carbon filter module.

The solution dispensing system may include a reservoir (for example, the reservoir 118) configured to store an antimicrobial solution. The solution dispensing system may further include a level sensor (for example, the level sensor 320) positioned within the reservoir. The level sensor is configured to detect a level of the antimicrobial solution in the reservoir. The reservoir may include a first reservoir outlet (for example, the first reservoir outlet 118a). solution dispensing system may further include an electronic pump mechanism (for example, the electronic pumping mechanism 120) coupled to the reservoir. The electronic pumping mechanism may include a first dispensing nozzle (for example, the first dispensing nozzle 120a). The electronic pumping mechanism may further include an electronic pump (for example, the electronic pump 120b) in fluid communication with the reservoir outlet and the first dispensing nozzle. The electronic pump is configured to draw the antimicrobial solution from the reservoir outlet. The electronic pump is further configured to dispense the antimicrobial solution through the first dispensing nozzle.

The control unit 110 communicatively coupled to each of the level sensor and the electronic pumping mechanism. The process 400 may include receiving, by a signal generating module (for example, the signal generating module 308), configuration information corresponding to a solution dispensing system from a user device (for example, the user device 314), at step 402. The configuration information may include at least one of a user-defined dispensing time interval or a user-defined dosage of the antimicrobial solution. The process 400 may further include determining in real-time, by the level determining module, the level of the antimicrobial solution in the reservoir through the level sensor, at step 404. Further, the process 400 may include generating in real-time, by the signal generating module, a dispensing signal for the electronic pumping mechanism based on the configuration information, the determined level, and a predefined threshold level, at step 406. the dispensing signal is one of an activation signal or an inactivation signal. The activation signal enables the electronic pumping mechanism to dispense the user-defined dosage of the antimicrobial solution at the user-defined dispensing time interval. The inactivation signal disables the electronic pumping mechanism to dispense the antimicrobial solution.

In some embodiments, the solution dispensing system may further include a mechanical pumping mechanism (for example, the mechanical pumping mechanism 122) coupled to the reservoir. The mechanical pumping mechanism is configured to dispense the antimicrobial solution from the reservoir. The mechanical pumping mechanism may include a push button (for example, the push button 122a). the mechanical pumping mechanism may further include a return spring (for example, the return spring 122b) coupled to the push button and the reservoir outlet. The return spring is configured to generate a suction pressure on the reservoir when the push button is pressed to draw the antimicrobial solution from the reservoir outlet. The return spring is further configured to dispense the antimicrobial solution through the dispensing nozzle.

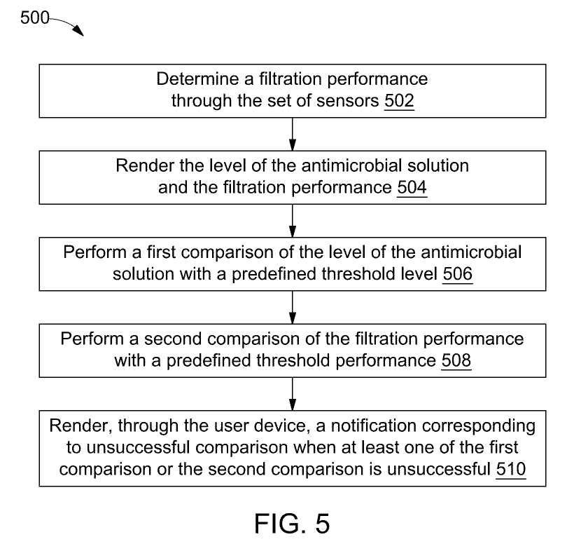

Referring now to FIG. 5, a flow diagram of an exemplary process 500 for determining a filtration performance of the water treatment cartridge 100 is illustrated, in accordance with some embodiments. FIG. 5 is explained in conjunction with FIGS. 1-4. The process 500 may be implemented by the control unit 110. The process 500 may include determining, by a performance determining module (for example, the performance determining module 312), a filtration performance through the set of sensors, at step 502. The filtration performance is indicative of at least one of a life of the set of filter modules (for example, the prefilter module 106a, the activated carbon filter module 106b, and the anti-scaling filter module 106c) or a filtration quality of the set of filter modules. The process 500 may further include rendering, by the performance determining module, the level of the antimicrobial solution and the filtration performance, at step 504. The process 500 may further include performing, by the performance determining module, a first comparison of the level of the antimicrobial solution with a predefined threshold level, at step 506. The process 500 may further include performing, by the performance determining module, a second comparison of the filtration performance with a predefined threshold performance, at step 508. The process 500 may further include rendering, by the performance determining module, a notification corresponding to unsuccessful comparison when at least one of the first comparison or the second comparison is unsuccessful, at step 510.

Thus, the disclosed method and system try to overcome the technical problem of operating water treatment cartridge. The disclosed method and system may receive configuration information corresponding to the solution dispensing system from a user device. Further, the disclosed method and system may determine in real-time, the level of the antimicrobial solution in the reservoir through the level sensor. Further, the disclosed method and system may generate in real-time, a dispensing signal for the electronic pumping mechanism based on the configuration information, the determined level, and a predefined threshold level.

The techniques described above relate to a water treatment cartridge. The above techniques may reduce scale buildup on water heater coils, pipes, and fixtures, thereby prolonging the lifespan of the appliances. The above techniques may reduce maintenance costs by minimizing frequent descaling or appliance replacements. The above techniques may prevent scale accumulation, thereby lowering energy consumption. The antimicrobial solution may offer natural antibacterial, antifungal, and anti-inflammatory benefits, helping to alleviate issues like dandruff, dry scalp, and skin conditions (for example, eczema and psoriasis). The above techniques may provide softened water. The softened water may reduce hair damage, tangling and dullness, making hair more manageable and shinier. The above techniques may provide IoT integration. The IoT integration may enable real-time monitoring of the water treatment cartridge performance and easy control of the antimicrobial solution through a mobile app. The above techniques may provide a modular design of the water treatment cartridge. The modular design may ensure easy installation, replacement and maintenance. The above techniques may eliminate the need for chemically treated water softeners and antimicrobial additives. The above techniques may reduce environmental impact by conserving energy through improved appliance efficiency.

The above techniques may allow users to adjust antimicrobial solution dosage based on individual preference or water quality requirements. The above techniques may lower expenses associated with frequent appliance repairs, replacements and energy inefficiencies caused by hard water. The above techniques may reduce the need for separate water softeners, antimicrobial agents, or hair or skin care treatments. The above techniques may combine water filtration, softening, antimicrobial treatment, and IoT- based monitoring in a single device, eliminating the need for multiple systems or products. The above techniques may be compatible with standard plumbing connections, making it suitable for various water sources and installation setups. The above techniques may promote overall well-being by delivering high-quality water for everyday use, reducing exposure to harmful effects of hard water.

In light of the above-mentioned advantages and the technical advancements provided by the disclosed device and mechanism, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

It is intended that the disclosure and examples be considered as exemplary only, with a true scope and spirit of disclosed embodiments being indicated by the following claims.

What is claimed is:

1. A water treatment cartridge comprising:
a solution dispensing system comprising:
a reservoir configured to store an antimicrobial solution, and wherein the reservoir comprises a reservoir outlet;
a level sensor positioned within the reservoir, wherein the level sensor is configured to detect a level of the antimicrobial solution in the reservoir; and
an electronic pumping mechanism coupled to the reservoir, wherein the electronic pumping mechanism comprises:
a dispensing nozzle; and
an electronic pump in fluid communication with the reservoir outlet and the dispensing nozzle, wherein the electronic pump is configured to:
draw the antimicrobial solution from the reservoir outlet; and
dispense the antimicrobial solution through the dispensing nozzle; and
a control unit communicatively coupled to each of the level sensor and the electronic pumping mechanism, wherein the control unit is configured to:
receive configuration information corresponding to the solution dispensing system from a user device, wherein the configuration information comprises at least one of a user-defined dispensing time interval or a user-defined dosage of the antimicrobial solution;
determine in real-time, the level of the antimicrobial solution in the reservoir through the level sensor; and
generate in real-time, a dispensing signal for the electronic pumping mechanism based on the configuration information, the determined level, and a predefined threshold level, wherein the dispensing signal is one of an activation signal or an inactivation signal.

2. The water treatment cartridge of claim 1, wherein:
the activation signal enables the electronic pumping mechanism to dispense the user-defined dosage of the antimicrobial solution at the user-defined dispensing time interval, and
the inactivation signal disables the electronic pumping mechanism to dispense the antimicrobial solution.

3. The water treatment cartridge of claim 1, wherein the solution dispensing system further comprises a mechanical pumping mechanism coupled to the reservoir, wherein the mechanical pumping mechanism is configured to dispense the antimicrobial solution from the reservoir, and wherein the mechanical pumping mechanism comprises:
a push button; and
a return spring coupled to the push button and the reservoir outlet, wherein the return spring is configured to:
generate a suction pressure on the reservoir when the push button is pressed to draw the antimicrobial solution from the reservoir outlet; and
dispense the antimicrobial solution through the dispensing nozzle.

4. The water treatment cartridge of claim 1, further comprising:
a housing enclosing the solution dispensing system and the control unit, wherein the housing comprises an inlet and an outlet, wherein the housing is retrofittable with a piping arrangement via the inlet and the outlet;
a set of sensors positioned at each of the inlet and the outlet, wherein the set of sensors comprises at least one of a flow sensor or a Total Dissolved Solids (TDS) sensor; and
a filtration system comprising a set of filter modules serially arranged within the housing in proximity to the inlet.

5. The water treatment cartridge of claim 4, wherein the control unit is further configured to:
determine a filtration performance through the set of sensors, wherein the filtration performance is indicative of at least one of a life of the set of filter modules or a filtration quality of the set of filter modules;
render, through the user device, the level of the antimicrobial solution and the filtration performance;
perform a first comparison of the level of the antimicrobial solution with the predefined threshold level;
perform a second comparison of the filtration performance with a predefined threshold performance; and
render, through the user device, a notification corresponding to unsuccessful comparison when at least one of the first comparison or the second comparison is unsuccessful.

6. The water treatment cartridge of claim 4, wherein the set of filter modules comprises:
a prefilter module positioned facing the inlet;
an activated carbon filter module serially positioned next to the prefilter module; and
an anti-scaling filter module serially positioned next to the activated carbon filter module.

7. A plumbing device comprising:
a water treatment cartridge comprising:
a solution dispensing system comprising:
a reservoir configured to store an antimicrobial solution, and wherein the reservoir comprises a reservoir outlet;
a level sensor positioned within the reservoir, wherein the level sensor is configured to detect a level of the antimicrobial solution in the reservoir; and
an electronic pumping mechanism coupled to the reservoir, wherein the electronic pumping mechanism comprises:
a dispensing nozzle; and
an electronic pump in fluid communication with the reservoir outlet and the dispensing nozzle, wherein the electronic pump is configured to:
draw the antimicrobial solution from the reservoir outlet; and
dispense the antimicrobial solution through the dispensing nozzle; and
a control unit communicatively coupled to each of the level sensor and the electronic pumping mechanism, wherein the control unit is configured to:
receive configuration information corresponding to the solution dispensing system from a user device, wherein the configuration information comprises at least one of a user-defined dispensing time interval or a user-defined dosage of the antimicrobial solution;
determine in real-time, the level of the antimicrobial solution in the reservoir through the level sensor; and
generate in real-time, a dispensing signal for the electronic pumping mechanism based on the configuration information, the determined level, and a predefined threshold level, wherein the dispensing signal is one of an activation signal or an inactivation signal.

8. The plumbing device of claim 7, wherein:
the activation signal enables the electronic pumping mechanism to dispense the user-defined dosage of the antimicrobial solution at the user-defined dispensing time interval, and
the inactivation signal disables the electronic pumping mechanism to dispense the antimicrobial solution.

9. The water treatment appliance of claim 7, wherein the solution dispensing system further comprises a mechanical pumping mechanism coupled to the reservoir, wherein the mechanical pumping mechanism is configured to dispense the antimicrobial solution from the reservoir, and wherein the mechanical pumping mechanism comprises:
a push button; and
a return spring coupled to the push button and the reservoir outlet, wherein the return spring is configured to:
generate a suction pressure on the reservoir when the push button is pressed to draw the antimicrobial solution from the reservoir outlet; and
dispense the antimicrobial solution through the dispensing nozzle.

10. The plumbing device of claim 7, wherein the water treatment cartridge further comprises:
a housing enclosing the solution dispensing system and the control unit, wherein the housing comprises an inlet and an outlet, wherein the housing is retrofittable with a piping arrangement via the inlet and the outlet;
a set of sensors positioned at each of the inlet and the outlet, wherein the set of sensors comprises at least one of a flow sensor or a Total Dissolved Solids (TDS) sensor; and
a filtration system comprising a set of filter modules serially arranged within the housing in proximity to the inlet.

11. The plumbing device of claim 10, wherein the control unit is further configured to:
determine a filtration performance through the set of sensors, wherein the filtration performance is indicative of at least one of a life of the set of filter modules or a filtration quality of the set of filter modules;
render, through the user device, the level of the antimicrobial solution and the filtration performance;
perform a first comparison of the level of the antimicrobial solution with a predefined threshold level;
perform a second comparison of the filtration performance with a predefined threshold performance; and
render, through the user device, a notification corresponding to unsuccessful comparison when at least one of the first comparison or the second comparison is unsuccessful.

12. The plumbing device of claim 7, wherein the set of filter modules comprises:
a prefilter module positioned facing the inlet;
an activated carbon filter module serially positioned next to the prefilter module; and
an anti-scaling filter module serially positioned next to the activated carbon filter module.

13. A method for operating a water treatment cartridge, the method comprising:
receiving, by a control unit, configuration information corresponding to a solution dispensing system from a user device, wherein the configuration information comprises at least one of a user-defined dispensing time interval or a user-defined dosage of the antimicrobial solution, wherein the solution dispensing system comprises:
a reservoir configured to store an antimicrobial solution, and wherein the reservoir comprises a reservoir outlet;
a level sensor positioned within the reservoir, wherein the level sensor is configured to detect a level of the antimicrobial solution in the reservoir; and
an electronic pumping mechanism coupled to the reservoir, wherein the electronic pumping mechanism comprises:
a dispensing nozzle; and
an electronic pump in fluid communication with the reservoir outlet and the dispensing nozzle, wherein the electronic pump is configured to:
draw the antimicrobial solution from the reservoir outlet; and
dispense the antimicrobial solution through the dispensing nozzle; and
determining in real-time, by the control unit, the level of the antimicrobial solution in the reservoir through the level sensor; and
generating in real-time, by the control unit, a dispensing signal for the electronic pumping mechanism based on the configuration information, the determined level, and a predefined threshold level, wherein the dispensing signal is one of an activation signal or an inactivation signal.

14. The method of claim 13, wherein:
the activation signal enables the electronic pumping mechanism to dispense the user-defined dosage of the antimicrobial solution at the user-defined dispensing time interval, and
the inactivation signal disables the electronic pumping mechanism to dispense the antimicrobial solution.

15. The method of claim 13, wherein the solution dispensing system further comprises a mechanical pumping mechanism coupled to the reservoir, wherein the mechanical pumping mechanism is configured to dispense the antimicrobial solution from the reservoir, and wherein the mechanical pumping mechanism comprises:
a push button; and
a return spring coupled to the push button and the reservoir outlet, wherein the return spring is configured to:
generate a suction pressure on the reservoir when the push button is pressed to draw the antimicrobial solution from the reservoir outlet; and
dispense the antimicrobial solution through the dispensing nozzle.

16. The method of claim 13, wherein a housing encloses the solution dispensing system and the control unit, wherein the housing comprises:
an inlet and an outlet, wherein the housing is retrofittable with a piping arrangement via the inlet and the outlet;
a set of sensors positioned at each of the inlet and the outlet, wherein the set of sensors comprises at least one of a flow sensor or a Total Dissolved Solids (TDS) sensor; and
a filtration system comprising a set of filter modules serially arranged within the housing in proximity to the inlet.

17. The method of claim 16, further comprising:
determining a filtration performance through the set of sensors, wherein the filtration performance is indicative of at least one of a life of the set of filter modules or a filtration quality of the set of filter modules;
rendering, through the user device, the level of the antimicrobial solution and the filtration performance;
performing a first comparison of the level of the antimicrobial solution with a predefined threshold level;
performing a second comparison of the filtration performance with a predefined threshold performance; and
rendering, through the user device, a notification corresponding to unsuccessful comparison when at least one of the first comparison or the second comparison is unsuccessful.

18. The method of claim 16, wherein the set of filter modules comprises:
a prefilter module positioned facing the inlet;
an activated carbon filter module serially positioned next to the prefilter module; and
an anti-scaling filter module serially positioned next to the activated carbon filter module.
